(19) United States
(12) Patent Application Publication
(10) Pub. No.: US 2019/0375401 A1
(43) Pub. Date: Dec. 12, 2019

(54) VEHICLE CONTROL SYSTEM

(71) Applicant: Honda Motor Co.,Ltd., Tokyo (JP)

(72) Inventors: Takuro SHIMIZU, Saitama (JP); Akiko NAKAGAWARA, Saitama (JP); Masayuki SADAKIYO, Saitama (JP)

(73) Assignee: Honda Motor Co.,Ltd., Tokyo (JP)

(21) Appl. No.: 16/424,499

(22) Filed: May 29, 2019

(30) Foreign Application Priority Data
Jun. 7, 2018 (JP) 2018-109584

(51) Int. Cl. B60W 30/09; B60W 30/095

(52) U.S. Cl. CPC B60W 30/09; B60W 30/095; B60W 2520/10; B60W 2550/10; B60W 2720/106; B60W 2550/30

(57) ABSTRACT

The disclosure provides a vehicle control system capable of mitigating the impact when an object collides with a vehicle by exerting active driving control on the vehicle, and capable of protecting an occupant. In a vehicle control system, a driving control part includes a relative speed calculating part which detects an advancing direction of an object approaching the vehicle and calculates a relative speed between the vehicle and the object approaching the vehicle, and an acceleration control part which, based on the relative speed, a position of the object, and the advancing direction of the object approaching the vehicle, in a case where it is determined that the object is going to collide with the vehicle, performs acceleration control to exert driving control which accelerates the vehicle in the advancing direction, so as to reduce the relative speed calculated by the relative speed calculating part.

### CROSS-REFERENCE TO RELATED APPLICATION

This application claims the priority benefit of Japan Application No. 2018-109584, filed on Jun. 7, 2018. The entirety of the above-mentioned patent application is hereby incorporated by reference herein and made a part of this specification.

### BACKGROUND

### Technical Field

The disclosure relates to a vehicle control system.

### Description of Related Art

Conventionally, a vehicle control device which controls a vehicle so that the safety of the occupant can be ensured when a collision of the vehicle is predicted has been proposed (e.g., Patent Document 1: Japanese Patent No. 4848678). According to the vehicle control device of Patent Document 1, in a state in which a collision of an oncoming vehicle to the own vehicle cannot be avoided, and in a case where a backward movement detecting means confirms that the own vehicle is in a backward moving state, the operation of a brake device s by a collision control means is restricted in a braking restricting mean, and an excessive braking force can be prevented from being provided to the own vehicle.

Also, a vehicle integrative control device including a collision preventing control device which detects an obstacle ahead and prevents a collision with the obstacle by braking and a front/rear driving force distribution control device which controls an engaging torque between front and rear shafts has been proposed (e.g., Patent Document 2: Japanese Patent No. 5663356). According to the vehicle integrative control device of Patent Document 2, when the collision preventing control device generates automatic braking and avoids the collision with the obstacle, the front and rear forces of the four wheels are maximally used while taking into consideration the operation of the ABS and the traveling state of the vehicle, and the vehicle can be stopped in a short braking distance.

In recent years, studies on automatic driving of vehicles have been pushed forward, and active driving control on vehicles is being carried out. For this purpose, even when a vehicle involves in a collision, it is required to exert active driving control on the vehicle to alleviate the impact of the collision to the vehicle.

### SUMMARY

An aspect of the disclosure provides a vehicle control system (e.g., the vehicle control system 1 to be described later) including a driving control part (e.g., the automatic driving control part 11 to be described later) capable of exerting driving control on a vehicle even if a driver does not perform operation, and includes: an external sensing device (e.g., the external sensing device 20 to be described later) which detects a position of an object present around the vehicle; a vehicle speed obtaining part (e.g., the vehicle sensor 50 to be described later) which obtains a vehicle speed of the vehicle; and a direction sensor (e.g., the vehicle sensor 50 to be described later) which detects an orientation of the vehicle. The drive control part includes: a relative speed calculating part (e.g., the relative speed calculating part 13 to be described later) which, based on the position of the object detected by the external sensing device, the vehicle speed obtained by the vehicle speed obtaining part, and the orientation detected by the direction sensor, detects an advancing direction of the object approaching the vehicle and calculates a relative speed between the vehicle and the object approaching the vehicle; and an acceleration control part (the acceleration control part 14 to be described later) which, based on the relative speed calculated by the relative speed calculating part, the position of the object detected by the external sensing device, and the advancing direction of the object approaching the vehicle detected by the relative speed calculating part, in a case where it is determined that the object is going to collide with the vehicle, performs acceleration control to exert driving control which accelerates the vehicle in the advancing direction, so as to reduce the relative speed calculated by the relative speed calculating part.

### BRIEF DESCRIPTION OF THE DRAWINGS

FIG. 1 is a diagram showing a configuration of a vehicle control system according to an embodiment of the disclosure.

FIG. 2 is a flowchart showing procedures of a process of a driving control part in the case where an object collides with a moving vehicle.

FIG. 3 is a flowchart showing procedures of a process of a driving control part in the case of a collision with a vehicle whose movement in the forward direction or the backward direction is restricted.

### DESCRIPTION OF THE EMBODIMENTS

The disclosure provides a vehicle control system capable of alleviating the impact when an object collides with the vehicle and protecting the occupant by exerting active driving control on the vehicle.

An aspect of the disclosure provides a vehicle control system (e.g., the vehicle control system 1 to be described later) including a driving control part (e.g., the automatic driving control part 11 to be described later) capable of exerting driving control on a vehicle even if a driver does not perform operation, and includes: an external sensing device (e.g., the external sensing device 20 to be described later) which detects a position of an object present around the vehicle; a vehicle speed obtaining part (e.g., the vehicle sensor 50 to be described later) which obtains a vehicle speed of the vehicle; and a direction sensor (e.g., the vehicle sensor 50 to be described later) which detects an orientation of the vehicle. The drive control part includes: a relative speed calculating part (e.g., the relative speed calculating part 13 to be described later) which, based on the position of the object detected by the external sensing device, the vehicle speed obtained by the vehicle speed obtaining part, and the orientation detected by the direction sensor, detects an advancing direction of the object approaching the vehicle and calculates a relative speed between the vehicle and the object approaching the vehicle; and an acceleration control part (the acceleration control part 14 to be described later) which, based on the relative speed calculated by the relative speed calculating part, the position of the object detected by the external sensing device, and the advancing direction of the object approaching the vehicle detected by the relative speed calculating part, in a case where it is determined that the object is going to collide with the vehicle, performs acceleration control to exert driving control which accelerates the vehicle in the advancing direction, so as to reduce the relative speed calculated by the relative speed calculating part.

According to an embodiment of the disclosure, the acceleration control part performs the acceleration control by accelerating the vehicle in a forward direction when the vehicle is moving forward or accelerating the vehicle in a backward direction when the vehicle is moving backward.

According to an embodiment of the disclosure, the driving control part includes: a moving direction predicting part (e.g., the moving direction predicting part 15 to be described later) which predicts a movement of the vehicle after the collision in the acceleration control; and a collision reducing vehicle turning control part (e.g., the collision reducing vehicle turning part 16 to be described later) which, based on the position of the object around the vehicle detected by the external sensing device and the movement of the vehicle predicted by the moving direction predicting part, in a case where it is determined that the vehicle is going to collide with the object around the vehicle, exerts driving control which changes the orientation of the vehicle to a direction in which the vehicle does not collide with the object around the vehicle or to a direction in which the collision to the object around the vehicle by the vehicle is alleviated.

According to the disclosure, by exerting active driving control on the vehicle, the vehicle control system capable of alleviating the impact when the object collides with the vehicle and protecting the occupant can be provided.

Hereinafter, an embodiment of the disclosure will be described in detail with reference to the drawings.

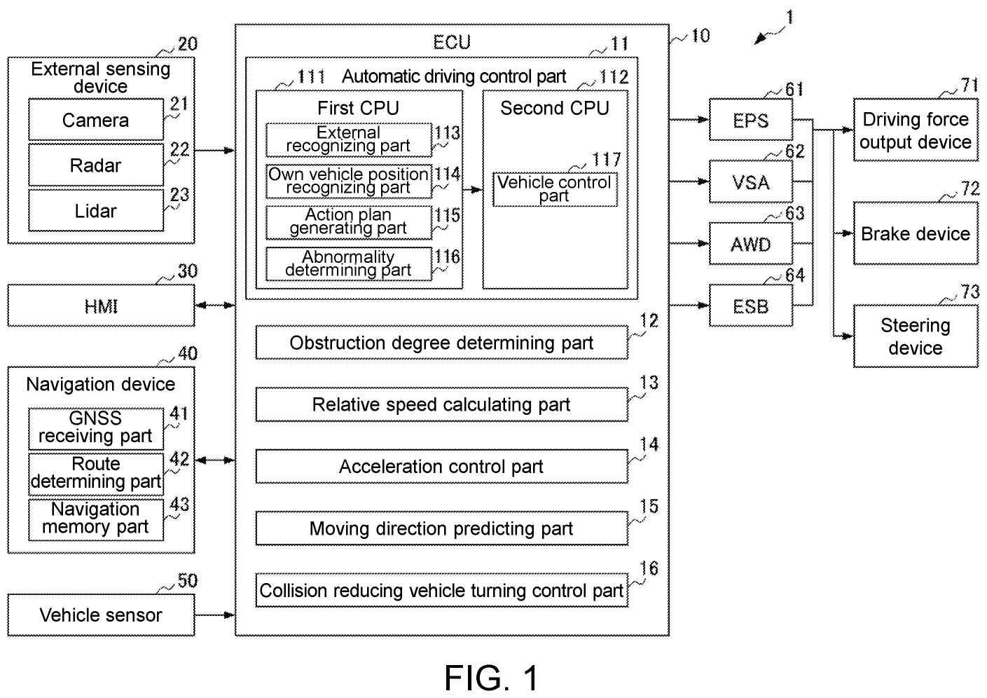

FIG. 1 is a diagram showing a configuration of a vehicle control system 1.

According to this embodiment, a vehicle on which the vehicle control system 1 is mounted is composed an electric vehicle capable of four-wheel driving, for example, which includes a so-called in-wheel motor whose output shaft is directly connected to each wheel of the four driving wheels. The vehicle control system 1 according to this embodiment has a configuration capable of automatically controlling driving of the vehicle, as described in detail later, and is capable of automatic driving equivalent to Level 3 defined by the Ministry of Land, Infrastructure, Transport, and Tourism.

As shown in FIG. 1, the vehicle control system 1 includes an ECU 10, an external sensing device 20, an human machine interface (HMI) 30, a navigation device 40, a vehicle sensor 50, an electric power steering (EPS) 61, a vehicle stability assist (VSA) 62, an all-wheel drive (AWD) 63, an electric servo brake (ESB) 64, a driving force output device 71, a brake device 72, and a steering device 73.

The external sensing device 20 includes a camera 21, a radar 22, and a lidar 23.

At least one camera 21 is provided at an arbitrary place of the own vehicle, and captures images around the own vehicle to obtain image information. The camera 21 is a monocular camera or a stereo camera, and a digital camera using a solid-state image capturing element such as CCD, CMOS, etc., for example, is used as the camera 21.

At least one radar 22 is provided at an arbitrary place of the own vehicle, and detects the position (the distance and the direction) of an object that is present around the own vehicle. Specifically, the radar 22 detects the position of the object by irradiating electromagnetic waves such as millimeter waves, etc., around the vehicle and detecting reflected waves reflected by the object on which the electromagnetic waves are irradiated.

At least one lidar 23 is provided at an arbitrary place of the own vehicle and detects the position (the distance and the direction) and properties of the object that is present around the own vehicle. Specifically, the lidar 23 detects the position and the properties of the object present within a distance longer than the radar 22 by irradiating electromagnetic waves (electromagnetic waves of ultraviolet light, visible light, near infrared light, etc.) having a shorter wavelength than the millimeter wave around the vehicle in a pulsed manner and detecting scattered waves scattered by the object on which the electromagnetic waves are irradiated.

The external sensing device 20 functions as an advanced driver assistance system (ADAS). Specifically, by using the sensor fusion technology, the external sensing device 20 comprehensively evaluates the respective information obtained by the camera 21, the radar 22, the lidar 23, etc., and outputs more accurate information to the ECU 10 to be described later in detail.

The HMI 30 is an interface which displays various information to the driver, etc., and receives an input operation by the driver, etc. The HMI 30 includes, for example, a display device, a seat belt device, a handle touch sensor, a driver monitor camera, various operation switches, etc., that are not shown herein.

The display device is a touch panel type display device which displays an image and accepts an operation by the driver, etc., for example. The seat belt device is configured as including a seat belt pretensioner, for example, and vibrates the seat belt and notify or warn the driver when automatic driving is switched to manual driving regardless of the driver's will due to a vehicle failure, etc., for example. The handle touch sensor is provided on the steering wheel of the vehicle and detects the contact of the driver with respect to the steering wheel and the pressure at which the driver grips the steering wheel. The driver monitors camera captures images of the face and the upper body of the driver. The various operation switches are configured as including, for example, a GUI type or a mechanical type automatic driving changeover switch which instructs to start and stop automatic driving, etc. Furthermore, the HMI 30 may include various communication devices having an external communication function.

The navigation device 40 includes a global navigation satellite system (GNSS) receiving part 41, a route determining part 42, and a navigation memory part 43. Further, the navigation device 40 includes a display device, a speaker, an operation switch, etc., for the driver, etc., to use the navigation device 40 in the HMI 30.

The GNSS receiving part 41 specifies the position of the vehicle based on a signal received from the GNSS satellite. However, the position of the vehicle may also be specified according to information obtained from the vehicle sensor 50 to be described later in detail.

The route determining part 42 refers to map information stored in the navigation memory part 43 to be described in the following and determines a route from the position of the own vehicle specified by the GNSS receiving part 41 to a destination input by the driver, etc., for example. The route determined by the route determining part 42 is introduced to the driver etc., by the display device, the speaker, etc., in the HMI 30.

The navigation memory part 43 stores a map position unit (MPU) with high precision map information. As the map information, for example, the road type, the numbers of lanes of roads, the positions of emergency parking zones, the width of lanes, the gradient of roads, the positions of roads, the curvature of lane curves, the merging and branching points of lanes, the information on road signs, etc., the position information of intersections, the presence/absence information of traffic lights, the position information of stop lines, the traffic jam information, the information of other vehicles, etc., for example, are included.

The navigation device 40 may also be constituted by a terminal device such as a smartphone or a tablet terminal, for example. In addition, the navigation device 40 includes various cellular networks, a telematics communication unit (TCU) which is an on-vehicle dedicated communication unit, etc., that are not shown herein, and is capable of sending information to and receiving information from a cloud server, etc. Thus, in addition to transmitting vehicle position information, etc., to the external, the map information is also updated at any time.

The vehicle sensor 50 includes a plurality of sensors for detecting various behaviors of the own vehicle. For example, the vehicle sensor 50 includes a speed sensor which detects the speed (vehicle speed) of the own vehicle, a wheel speed sensor which detects the speed of each wheel of the own vehicle, a longitudinal acceleration sensor which detects the acceleration/deceleration of the own vehicle, a lateral acceleration sensor which detects the lateral acceleration of the own vehicle, a yaw rate sensor which detects the yaw rate of the own vehicle, a direction sensor which detects the orientation of the own vehicle, a gradient sensor which detects the gradient of the own vehicle, etc.

Further, the vehicle sensor 50 includes a plurality of sensors which detect operation amounts of various operation devices. For example, the vehicle sensor 50 includes an accelerator pedal sensor which detects the depression amount (opening degree) of the accelerator pedal, a steering angle sensor which detects the operation amount (steering angle) of the steering wheel, a torque sensor which detects the steering torque, a brake pedal sensor which detects the depression amount of the brake pedal, a shift sensor which detects the position of the shift lever, etc.

The EPS 61 is a so-called electric power steering device. The EPS 61 includes an EPS ECU not shown herein, and changes the orientation of the wheels (steering wheel) by controlling a steering device 73, which will be described later, in accordance with the control command output from the ECU 10 to be described later in detail.

The VSA 62 is a so-called vehicle behavior stabilization control device. The VSA 62 includes a VSA ECU not shown herein, and has the ABS function which prevents the wheels from being locked during a braking operation, the traction control system (TCS) function which prevents the wheels from idling during acceleration, etc., a function of suppressing lateral sliding, etc., at the time of turning, and the function of performing emergency braking control in spite of the braking operation of the driver at a collision of the own vehicle. In order to realize these functions, the VSA 62 supports vehicle behavior stabilization by adjusting the brake hydraulic pressure generated at the ESB 64 to be described later.

Specifically, the VSA 62 controls the brake device 72, which will be described later, based on the vehicle speed, the steering angle, the yaw rate, and the lateral acceleration, etc., detected by the vehicle speed sensor, the steering angle sensor, the yaw rate sensor, and the lateral acceleration sensor. Specifically, by controlling the hydraulic unit that supplies the brake hydraulic pressure to the brake cylinder for each of the left and right wheels at the front and the rear, the braking forces of the respective wheels are individually controlled and the traveling stability is improved.

The AWD 63 is a so-called the super handling all-wheel-drive (SH-AWD) control system and functions as a driving force distribution control part. That is, the AWD 63 includes an AWD ECU not shown herein, and freely controls the front and rear wheels and the distribution of the driving forces of the left and right of the front wheels as well as the distribution of the driving forces of the left and right of the rear wheels. Specifically, based on the vehicle speed, the steering angle, the yaw rate, and the lateral acceleration, etc., detected by the vehicle speed sensor, the steering angle sensor, the yaw rate sensor, and the lateral acceleration sensor, the AWD 63 changes the distribution of the driving forces among the wheels at the left and the right of the front and the rear by controlling the electromagnetic clutch, etc., in the front, rear, left, and right driving force distribution unit.

The ESB 64 includes an ESB ECU not shown herein and generates the braking force on the wheels by controlling the brake device 72, which will be described later, in accordance with the control command output from the ECU 10 to be described later in detail.

The driving force output device 71 is composed of an electric motor, etc., serving as the driving source of the own vehicle. The driving force output device 71 generates a traveling driving force (torque) for the own vehicle to travel according to a control command output from the ECU 10 to be described later in detail, and transmits the traveling driving force to each wheel via the transmission.

The brake device 72 is composed of, for example, an electric servo brake using a hydraulic brake in combination. The brake device 72 brakes the wheels in accordance with the control command output from the ECU 10 to be described later in detail.

The steering device 73 is controlled by the EPS 61 described above and changes the orientation of the wheels (steering wheel).

Next, the ECU 10 included in the vehicle control system 1 according to this embodiment will be described in detail.

As shown in FIG. 1, the ECU 10 includes an automatic driving control part 11, an obstruction degree determining part 12, a relative speed calculating part 13, an acceleration control part 14, a moving direction predicting part 15, and a collision reducing vehicle turning control part 16.

The automatic driving control part 11 is configured as including a first CPU 111 and a second CPU 112.

The first CPU 111 is configured as including an external recognizing part 113, an own vehicle position recognizing part 114, an action plan generating part 115, and an abnormality determining part 116.

Based on various information obtained by the external sensing device 20, the external recognizing part 113 recognizes an external object (target of recognition) and the position of the external object. Specifically, the external recognizing part 113 recognizes an obstacle, the profile of a road, a traffic light, a guardrail, an utility pole, a nearby vehicle (including the traveling condition such as the speed and the acceleration, the parking condition, etc.), a lane mark, a pedestrian, etc., as well as the position thereof.

The own vehicle position recognizing part 114 recognizes the current position and posture of the own vehicle based on the position information of the own vehicle measured by the navigation device 40 and various sensor information detected by the vehicle sensor 50. Specifically, by comparing the map information and the image obtained by the camera 21, the own vehicle position recognizing part 114 recognizes the traveling lane in which the own vehicle travels and recognizes the relative position and posture of the own vehicle with respect to the traveling lane.

The action plan generating part 115 generates an automatic driving action plan until the arrival of the own vehicle to the destination, etc. More specifically, based on the external information recognized with the external recognizing part 113 and the own vehicle position information recognized by the own vehicle position recognizing part 114, in correspondence with the state of the own vehicle and the state of the surrounding, the action plan generating part 115 generates the automatic driving action plan, so as to be able to travel on the route determined by the route determining part 42.

Specifically, the action plan generating part 115 generates a target path along which the own vehicle will travel. More specifically, the action plan generating part 115 generates a plurality of target path candidates, and selects an optimum target path at the moment from the viewpoint of safety and efficiency. Further, the action plan generating part 115 generates an action plan of stopping the own vehicle at a safe place (an emergency parking zone, a roadside zone, a road shoulder, a parking area, etc.), for example, in the case where the abnormality determining part 116, which will be described later in detail, determines that the occupant or the own vehicle is in an abnormal state.

The abnormality determining part 116 determines whether at least one of the driver and the own vehicle is in the abnormal state. Then abnormal state of the driver includes, for example, deterioration of a physical condition, a state in which the occupant is asleep or in an unconscious state due to illness, etc. In addition, the abnormal state of the own vehicle includes a failure of the own vehicle, etc.

Specifically, the abnormality determining part 116 determines the abnormal state of the driver by analyzing the image obtained by the driver monitor camera. Also, when automatic driving is mandatorily switched to manual driving regardless of the driver's will due to a failure of the own vehicle, etc., for example, in the case where a manual driving operation of the driver is not detected in spite of having warned the driver for more than a predetermined number of times through display, sounds, or vibration of the seat belt, etc., the abnormality determining part 116 determines that the driver is in the abnormal state. The manual driving operation of the driver is detected by the handle touch sensor, the accelerator pedal sensor, the brake pedal sensor, etc.

Also, the abnormality determining part 116 detects the presence/absence of a failure of the own vehicle based on the various sensor information obtained by the vehicle sensor 50, etc., and determines that the own vehicle is in the abnormal state when the failure is detected.

The second CPU 112 is configured as including a vehicle control part 117. The external information, the own vehicle position information, the action plan, and the abnormality information obtained at the first CPU 111 is input to the vehicle control part 117 constituting the second CPU 112.

The vehicle control part 117 starts/stops automatic driving according to an automatic driving start/stop signal input from the automatic driving changeover switch. Also, the vehicle control part 117 controls the driving force output device 71, the brake device 72 and the steering device 73 via the EPS 61, the VSA 62, the AWD 63, and the ESB 64, etc., so that the own vehicle travels at a target speed along the target path generated at the action plan generating part 115.

The obstruction degree determining part 12 predicts the course of the vehicle 1 based on the relative distance and the relative speed of the object (an obstacle, another vehicle, etc.) with respect to the own vehicle obtained by the external sensing device 20, data respectively detected by the steering angle sensor, the yaw rate sensor, etc., of the vehicle sensor 50 of the own vehicle, and calculates the obstruction degree. Then, the obstruction degree determining part 12 determines the obstruction degree of an arbitrary object with respect to the own vehicle according to a predetermined obstruction degree map not shown herein, and determines whether the own vehicle can avoid the collision with respect to the object accordingly.

Based on the orientation of the own vehicle detected by the direction sensor of the vehicle sensor 50, the speed (vehicle speed) of the own vehicle detected by the speed sensor of the vehicle sensor 50, and the object speed (vehicle speed in the case of another vehicle) of the object (an obstacle, another vehicle, etc.) obtained by the external sensing device 20 based on the relative distance (the position of the object) with respect to the own vehicle, the relative speed calculating part 13 calculates the relative speed between the own vehicle and the object approaching the own vehicle and detects the advancing direction of the object (another vehicle, etc.) approaching the own vehicle.

In the case where the obstruction degree determining part 12 determines that the object (another vehicle, etc.) is going to collide with the own vehicle, the acceleration control part 14 performs acceleration control to exert driving control which accelerates the own vehicle in the advancing direction of the object (another vehicle, etc.), so that the relative speed calculated by the relative speed calculating part 13 is reduced.

More specifically, the acceleration control part 14 performs control on the vehicle control part 117, so that the relative speed between the own vehicle and the object (another vehicle, etc.) in the moving direction of the own vehicle becomes a predetermined value at which the occupant of the own vehicle can be protected.

The moving direction predicting part 15 predicts the movement (the moving direction and the moving speed) of the own vehicle after the collision due to the collision to the own vehicle by another vehicle based on the relative distance and the relative speed of the object (an obstacle, another vehicle, etc.) obtained by the external sensing device 20 with respect to the own vehicle, the data respectively detected by the steering angle sensor, the yaw rate sensor, etc., of the vehicle sensor 50 of the own vehicle.

In the case where it is determined that the own vehicle is going to collide with the object (a wall, a parking vehicle, a median strip, etc.) around the own vehicle due to the movement of the own vehicle predicted by the moving direction predicting part 15, the collision reducing vehicle turning control part 16 performs control on the vehicle control part 117, so as to exert driving control which changes the orientation of the own vehicle to a direction in which the own vehicle does not collide with the object around the own vehicle or a direction in which a collision to the object around the own vehicle by the own vehicle is alleviated.

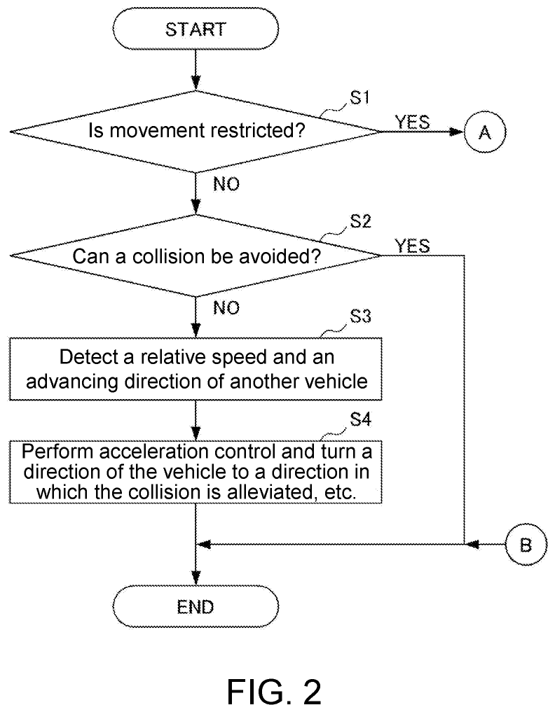

Next, the driving control, which is the control executed in the vehicle control system 1 of this embodiment including the above configuration, of the vehicle in the case where a collision by another vehicle cannot be avoided during traveling of the vehicle is described in detail in the following with reference to FIG. 2.

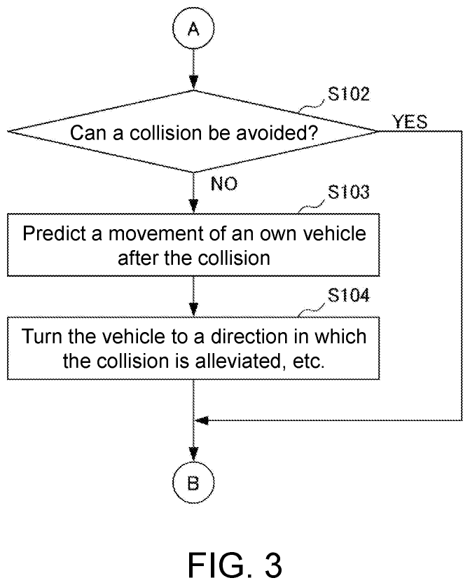

FIG. 2 is a flowchart showing procedures of a process of a driving control part in the case where the object collides with the moving vehicle. FIG. 3 is a flowchart showing procedures of a process of the driving control part in the case of a collision with a vehicle whose movement in the forward direction or the backward direction is restricted.

In Step S1, whether the movement of the vehicle in the forward direction or the backward direction is restricted is determined. Specifically, whether there is a circumstance in which the movement of the vehicle in the forward direction or the backward direction due to presence of another parking vehicle in at least one of the front and the rear when the vehicle is trying to park in a parking lot is determined. If the determination is NO, the process proceeds to Step S2, and if the determination is YES, the process proceeds to Step S102 (see FIG. 3). The process from Step S2 to Step S4 constitutes the acceleration control.

In Step S2, in the obstacle degree determining part 12, whether a collision to the own vehicle by another vehicle approaching the own vehicle from the front or the rear can be avoided is determined. If the determination is NO, the process proceeds to step S3, and if the determination is YES, the process ends.

In Step S3, in the relative speed calculating part 13, the relative speed between the own vehicle and the object approaching the own vehicle is calculated, and the advancing direction of the object (another vehicle, etc.) approaching the own vehicle is detected. After the detection, the process proceeds to Step S4.

In Step S4, in the acceleration control part, acceleration control which exerts driving control on the vehicle is performed, so as to reduce the relative speed. That is, control is performed on the vehicle control part 117, so that the own vehicle accelerates in the advancing direction of the object (another vehicle, etc.) detected in Step S3 to reduce the relative speed. Specifically, in the case where the object (another vehicle, etc.) is going to collide from the rear when the own vehicle is moving forward, the acceleration control part controls to accelerate in the forward direction, and in the case where the object (another vehicle, etc.) is going to collide from the front when the own vehicle is moving backward, the acceleration control part performs control to accelerate in the backward direction. After the control, the process ends.

In Step S102, in the obstruction degree determining part 12, whether a collision to the own vehicle by another vehicle approaching the own vehicle from all directions can be avoided is determined. If the determination is NO, the process proceeds to Step S103, and if the determination is YES, the process ends.

In Step S103, in the moving direction predicting part 15, the movement (the moving direction and the moving speed) of the own vehicle after the collision due to the collision to the own vehicle by another vehicle is predicted. After the prediction, the process proceeds to Step S104.

In Step S104, in the collision reducing vehicle turning control part 16, control is performed on the vehicle control part 117, so as to exert driving control that changes the orientation of the own vehicle to a direction in which the own vehicle does not collide with the object around the own vehicle, if such direction is available, and to a direction which alleviates the collision to the object around the own vehicle by the own vehicle in the case where the own vehicle collides with the object around the own vehicle. Specifically, in the case where there is a wall or a parking vehicle around the own vehicle, driving control is exerted to change the orientation of the own vehicle to a direction in which the own vehicle does not collide with the wall or the parking vehicle. After the control, the process ends.

According to the vehicle control system of this embodiment, the following effects are exhibited.

In the vehicle control system according to this embodiment, the automatic driving control part 11 as a driving control part includes: the relative speed calculating part 13 which, based on the position of the object detected by the external sensing device 20, the vehicle speed obtained by the speed sensor of the vehicle sensor 50 as a vehicle speed obtaining part, and the orientation detected by the direction sensor, detects the advancing direction of the object approaching the vehicle and calculates the relative speed between the vehicle and the object approaching the vehicle; and the acceleration control part 14 which, based on the relative speed calculated by the relative speed calculating part 13, the position of the object detected by the external sensing device 20, and the advancing direction of the object approaching the vehicle detected by the relative speed calculating part 13, in a case where it is determined that the object is going to collide with the vehicle, performs acceleration control to exert driving control which accelerates the vehicle in the advancing direction, so as to reduce the relative speed calculated by the relative speed calculating part 13.

Accordingly, since the own vehicle performs driving control before the object such as another vehicle collides with the vehicle, so that the relative speed between the own vehicle and the another vehicle is reduced regardless of the driver's will, when the object such as the another vehicle collides with the own vehicle, the impact to the own vehicle due to the collision can be suppressed, and the impact to the occupant of the vehicle can be suppressed. As a result, the occupant can be protected.

Also, in this embodiment, the acceleration control part performs the acceleration control by accelerating the vehicle in a forward direction when the vehicle is moving forward or accelerating the vehicle in a backward direction when the vehicle is moving backward.

Accordingly, when the own vehicle is moving forward, in the case where the object such as another vehicle approaches and collides with the own vehicle from the rear, in the own vehicle, control is performed so as to accelerate toward the front to reach a speed close to the speed at which the another vehicle approaches, and the relative speed can be reduced. Also, when the own vehicle is moving backward, in the case where the object such as another vehicle approaches and collides with the own vehicle from the front, in the own vehicle, control is performed so as to accelerate toward the rear to reach a speed close to the speed at which the another vehicle approaches, and the relative speed can be reduced.

In addition, in this embodiment, the driving control part includes: a moving direction predicting part which predicts a movement of the vehicle after the collision in the acceleration control; and a collision reducing vehicle turning control part which, based on the position of the object around the vehicle detected by the external sensing device and the movement of the vehicle predicted by the moving direction predicting part, in a case where it is determined that the vehicle is going to collide with the object around the vehicle, exerts driving control which changes the orientation of the vehicle to a direction in which the vehicle does not collide with the object around the vehicle or to a direction in which the collision to the object around the vehicle by the vehicle is alleviated.

Accordingly, after the object such as another vehicle collides with the own vehicle, the collision with the object around the own vehicle can be avoided, or the collision with the object around the own vehicle can be alleviated.

In addition, in this embodiment, the automatic driving control part 11 as the driving control part includes: the relative speed calculating part 13 which, based on the position of the object detected by the external sensing device 20, the vehicle speed obtained by the speed sensor of the vehicle sensor 50 as the vehicle speed obtaining part, and the orientation detected by the direction sensor, detects the advancing direction of the object approaching the vehicle and calculates the relative speed between the vehicle and the object approaching the vehicle; the moving direction predicting part 15 which predicts the movement of the vehicle after the collision based on the relative speed calculated by the relative speed calculating part 13, the position of the object detected by the external sensing device 20, and the advancing direction of the object approaching the vehicle detected by the relative speed calculating part 13; and the collision reducing vehicle turning control part 16 which, based on the position of the object around the vehicle detected by the external sensing device 20 and the movement of the vehicle predicted by the moving direction predicting part 15, in the case where it is determined that the vehicle is going to collide with the object around the vehicle, exerts driving control which changes the orientation of the vehicle to the direction in which the vehicle does not collide with the object around the vehicle or to the direction in which the collision to the object around the vehicle by the vehicle is alleviated.

Accordingly, before the object such as another vehicle collides with the vehicle, the own vehicle can be turned to the direction in which the collision with respect to the object around the own vehicle is suppressed after the collision regardless of the driver's will. As a result, after the object such as another vehicle collides with the own vehicle, the collision of the own vehicle with the object around the own vehicle can be suppressed, and the impact to the occupant can be suppressed.

Further, in this embodiment, the AWD 63 as the driving force distribution control part which distributes the driving force to the four driving wheels of the vehicle is provided. Accordingly, the turning as the driving control which changes the orientation of the vehicle in the case where the movement of the vehicle in the forward direction or the backward direction is restricted can be easily performed in a narrow space.

It is noted that the disclosure is not limited to the above embodiment, and includes variations, improvements, etc., within the scope that the object of the disclosure can be achieved.

For example, in the above embodiment, even though an electric vehicle as a vehicle in which the vehicle control system 1 is mounted is exemplified for descriptions, the vehicle control system 1 may also be mounted in an engine vehicle, a hybrid vehicle, a fuel cell vehicle, etc.

Also, the vehicle control system 1 according to this embodiment has a configuration capable of automatically controlling the driving of the vehicle and is capable of automatic driving equivalent to Level 3 defined by the Ministry of Land, Infrastructure, Transport, and Tourism. However, the vehicle control system 1 is not limited thereto. For example, it may also be that the vehicle control system 1 is not capable of automatic driving equivalent to Level 1 defined by the Ministry of Land, Infrastructure, Transport, and Tourism. Therefore, even though the vehicle is not capable of automatic driving control, it suffices as long as the vehicle is capable of exerting driving control in a broad sense, such as accelerating to change the speed of the vehicle, changing the orientation of the vehicle, etc.

In addition, the method of calculating the relative speed and detecting the position of the object is not limited to the method of calculating the relative speed and detecting the position of the object in this embodiment. Also, the method of predicting the movement of the own vehicle after a collision due to the collision to another vehicle is not limited to the method of predicting the movement of the own vehicle after the collision due to the collision to another vehicle by the moving direction predicting part in this embodiment.

Also, even though the vehicle in which the vehicle control system 1 includes the so-called in-wheel motor whose output shaft is directly connected to each wheel of the four driving wheels and is configured as a four-wheel drive electric vehicle, the vehicle is not limited thereto. For example, the vehicle may also be a four-wheel drive vehicle not including the in-wheel motor, or the vehicle may be four-wheel steerable, or the vehicle may be a front wheel drive vehicle or a rear wheel drive vehicle. Also, the number of wheels is not limited to four.

What is claimed is:

1. A vehicle control system, comprising a driving control part capable of exerting driving control on a vehicle even if a driver does not perform operation, the vehicle control system comprising:
an external sensing device which detects a position of an object present around the vehicle;
a vehicle speed obtaining part which obtains a vehicle speed of the vehicle; and
a direction sensor which detects an orientation of the vehicle,
wherein the driving control part comprises:
a relative speed calculating part which, based on the position of the object detected by the external sensing device, the vehicle speed obtained by the vehicle speed obtaining part, and the orientation detected by the direction sensor, detects an advancing direction of the object approaching the vehicle and calculates a relative speed between the vehicle and the object approaching the vehicle; and
an acceleration control part which, based on the relative speed calculated by the relative speed calculating part, the position of the object detected by the external sensing device, and the advancing direction of the object approaching the vehicle detected by the relative speed calculating part, in a case where it is determined that the object is going to collide with the vehicle, performs acceleration control to exert driving control which accelerates the vehicle in the advancing direction, so as to reduce the relative speed calculated by the relative speed calculating part.

2. The vehicle control system according to claim 1, wherein the acceleration control part performs the acceleration control by accelerating the vehicle in a forward direction when the vehicle is moving forward or accelerating the vehicle in a backward direction when the vehicle is moving backward.

3. The vehicle control system according to claim 1, wherein the driving control part comprises:
a moving direction predicting part which predicts a movement of the vehicle after the collision in the acceleration control; and
a collision reducing vehicle turning control part which, based on the position of the object around the vehicle detected by the external sensing device and the movement of the vehicle predicted by the moving direction predicting part, in a case where it is determined that the vehicle is going to collide with the object around the vehicle, exerts driving control which changes the orientation of the vehicle to a direction in which the vehicle does not collide with the object around the vehicle or to a direction in which the collision to the object around the vehicle by the vehicle is alleviated.

4. The vehicle control system according to claim 2, wherein the driving control part comprises:
a moving direction predicting part which predicts a movement of the vehicle after the collision in the acceleration control; and
a collision reducing vehicle turning control part which, based on the position of the object around the vehicle detected by the external sensing device and the movement of the vehicle predicted by the moving direction predicting part, in a case where it is determined that the vehicle is going to collide with the object around the vehicle, exerts driving control which changes the orientation of the vehicle to a direction in which the vehicle does not collide with the object around the vehicle or to a direction in which the collision to the object around the vehicle by the vehicle is alleviated.
